(19) United States
(12) Patent Application Publication
(10) Pub. No.: US 2025/0291020 A1
(43) Pub. Date: Sep. 18, 2025

(54) CONTROL APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventor: KAZUYUKI TOTA, Kanagawa (JP)

(21) Appl. No.: 19/221,753

(22) Filed: May 29, 2025

Related U.S. Application Data
(63) Continuation of application No. PCT/JP2023/040497, filed on Nov. 10, 2023.

(30) Foreign Application Priority Data
Dec. 27, 2022 (JP) 2022-210203

(51) Int. Cl. G01S 5/00; G01S 5/02

(52) U.S. Cl. CPC G01S 5/01; G01S 5/0244

(57) ABSTRACT

A control apparatus for controlling positioning based on communication between one or more cellular base station and a terminal performs: obtaining a detection result of a wireless signal transmitted from the one or more cellular base station, which is detected by the terminal; selecting one of a plurality of positioning methods based on the obtained detection result; and controlling to execute positioning processing using the positioning method, wherein if the detection result is a first detection result, a first positioning method based on a radio wave state between the one or more cellular base station and the terminal is selected, and if the detection result is a second detection result, a second positioning method different from the first positioning method based on the radio wave state between the one or more cellular base station and the terminal is selected.

### CROSS-REFERENCE TO RELATED APPLICATIONS

This application is a Continuation of International Patent Application No. PCT/JP2023/040497, filed Nov. 10, 2023, which claims the benefit of Japanese Patent Application No. 2022-210203, filed Dec. 27, 2022, both of which are hereby incorporated by reference herein in their entirety.

### BACKGROUND

### Field of the Technology

The present disclosure relates to a control apparatus that controls positioning processing based on communication between a base station and a terminal, a control method, and a non-transitory computer-readable storage medium.

### Description of the Related Art

A 5th generation wireless mobile communication system (5G system) that is introduced to a wireless communication system including a public portable telephone base station (cellular base station) and a mobile terminal connected to it has been examined. In the 5G system, not only portable telephones but also a variety of wireless communication apparatuses including automobiles, construction machines, and robots are connected to the cellular base station. Assuming a wireless communication apparatus that provides various services, an application not only to emergency call position specification or navigation but also to various services has been examined, and demands for positioning (position measurement) of wireless communication apparatuses are increasing.

In LTE (Long Term Evolution) or 5G NR (New Radio) of 3GPP (3rd Generation Partnership Project)®, a plurality of positioning methods by communication using radio waves with a cellular base station have been proposed. This enables positioning even indoors or underground, and it is expected that the positioning enable range is expanded and positioning accuracy is improved. PTL 1 discloses a method of improving lowering of positioning accuracy using an OTDOA (Observed Time Difference Of Arrival) method in which position measurement is performed based on the detection result of radio waves transmitted from a plurality of cellular base stations.

### CITATION LIST

### Patent Literature

PTL 1: Japanese Patent No. 6495540

As described above, in the LTE and 5G NR of 3GPP®, a plurality of positioning methods have been proposed. Here, depending on the positioning method, positioning accuracy sometimes lowers due to the wireless environment between a specific cellular base station and a terminal.

### SUMMARY

The present disclosure has been made in consideration of the above-described problem, and has as its object to prevent lowering of positioning accuracy due to the wireless environment between a base station and a terminal.

In order to solve the above-described problem, according to one aspect of the present disclosure, there is provided a control apparatus for controlling positioning based on communication between one or more cellular base station and a terminal, comprising:
at least one memory that stores a set of instructions; and
at least one processor that executes the instructions, the instructions, when executed, causing the control apparatus to perform operations comprising:
obtaining a detection result of a wireless signal transmitted from the one or more cellular base station, which is detected by the terminal;
performing selection processing for selecting one of a plurality of positioning methods based on the obtained detection result; and
controlling to execute positioning processing using the positioning method selected by the selection processing,
wherein in the selection processing, in a case where the detection result is a first detection result, a first positioning method based on a radio wave state between the one or more cellular base station and the terminal is selected, and in a case where the detection result is a second detection result, a second positioning method, which is different from the first positioning method, based on the radio wave state between the one or more cellular base station and the terminal is selected.

Features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain principles of the disclosure.

FIG. 1 is a view showing an example of the configuration of a positioning system including a terminal apparatus and a base station apparatus according to the embodiment.

FIG. 2 is a block diagram of the positioning system.

FIG. 3 is a sequence chart showing a procedure of executing positioning of the terminal apparatus according to the embodiment.

FIG. 4 is a sequence chart of processing executed between the terminal apparatus and an LMF according to the embodiment.

FIG. 5A is a flowchart showing an example of processing executed by the terminal apparatus according to the embodiment.

FIG. 5B is a flowchart showing an example of processing executed by the terminal apparatus according to the embodiment.

FIG. 6 is a view showing groups of positioning methods.

FIG. 7 shows an example of thresholds of an RSRP and an SNR of a PRS.

FIG. 8 is a block diagram showing the hardware configuration of the terminal apparatus according to the embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to an disclosure that requires all such features, and multiple such features may be combined as appropriate. Furthermore, in the attached drawings, the same reference numerals are given to the same or similar configurations, and redundant description thereof is omitted.

### First Embodiment

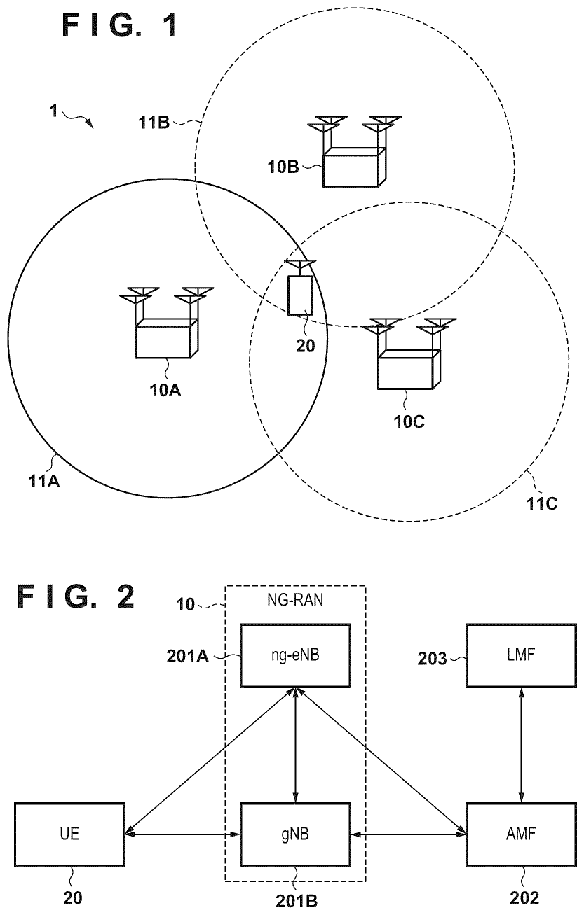

FIG. 1 is a view showing the configuration of a positioning system according to this embodiment. A positioning system 1 includes base station apparatuses 10A to 10C (to be sometimes referred to as “base station apparatus 10” hereinafter without discrimination), and a terminal apparatus 20. The base station apparatus 10 is, for example, a public portable telephone base station and is called an NG-RAN (Next Generation-Radio Access Network) or an AN (Access Network) in the 5G (5th generation) system. The terminal apparatus 20 is a mobile wireless communication apparatus and is also called a UE (user apparatus). Note that as will be described later with reference to FIG. 2, the positioning system 1 includes network nodes.

The base station apparatuses 10A to 10C include coverage areas 11A to 11C (to be sometimes referred to as “coverage area 11” hereinafter without discrimination), respectively. The coverage areas 11A to 11C may be cells of the same frequency or cells of different frequencies. The base station apparatus 10 can establish connection to a communication apparatus in the coverage area 11. In this embodiment, the terminal apparatus 20 is connected to the base station apparatus 10A. In this case, the coverage area 11A may be called a serving cell, and the coverage areas 11B and 11C may be called adjacent cells 11B and 11C. If the UE 20 is located in the range of the serving cell 11A, positioning of the UE 20 by the positioning system 1 can be performed.

Note that in this embodiment, the positioning system 1 can perform positioning using a plurality of positioning methods. The positioning methods include OTDOA (Observed Time Difference Of Arrival), E-CID (Enhanced Cell ID) positioning, DL-TDOA (Downlink-Time Difference of Arrival), DL-AoD (Downlink-Angle of Departure), Multi-RTT (Roundtrip Time) positioning, UL-TDOA (Uplink-Time Difference of Arrival), and UL-AoA (Uplink-Angle of Arrival). The positioning methods include positioning methods of performing positioning by communication between the UE 20 and one base station apparatus 10, and positioning methods that need communication between the UE 20 and a plurality of base station apparatuses 10. To perform positioning of the UE 20 using such positioning methods, the UE 20 needs to be located in the coverage areas 11 of the plurality of base station apparatuses 10.

Conventionally, in the positioning system capable of performing positioning of the UE 20 using a plurality of positioning methods, the positioning method is decided based on the specifications of the base station apparatus 10 of the serving cell and the relationship to adjacent cells and positioning methods supported by the UE 20. However, when deciding the positioning method by the positioning system, the wireless environment between the UE 20 and the base station apparatus 10 is not taken into consideration. Hence, in a case where the communication quality between the UE 20 and the specific base station apparatus 10 is low because of, for example, the location of the UE 20 at the cell end, if positioning is executed between the base station apparatus 10 and the UE 20, lowering of positioning accuracy or time required for positioning may be large. In the following explanation, processing of the positioning system 1 to decide the positioning method in consideration of the communication environment of the UE 20 will be described.

FIG. 2 is a functional block diagram of the positioning system 1 according to this embodiment. The UE 20 performs communication with the base station apparatus 10 by transmitting/receiving electromagnetic waves. The base station 10 includes an ng-eNB 201A that operates as an LTE base station complying with the LTE (Long Term Evolution) standard of 3GPP®. Also, the base station 10 includes a gNB 201B that operates as a 5G NR base station complying with the 5th generation (5G) NR (New Radio) standard of 3GPP®. The UE 20 establishes wireless communication of the LTE method or establishes wireless communication of the 5G NR method via the base station 10. That is, the UE 20 is a terminal apparatus capable of performing communication complying with the 3GPP® standard.

Communication between the UE 20 and the base station apparatus 10 is controlled by an Access and Mobility Management Function (AMF) 202. Processing associated with position measurement is controlled by a Location Management Function (LMF) 203, and the LMF 203 controls the base station apparatus 10 and the UE 20 via the AMF 202.

Note that the function of each of the AMF 202 and the LMF 203 may be implemented by a plurality of communication apparatuses. Also, the base station apparatus 10 may have the function of at least one of the AMF 202 and the LMF 203.

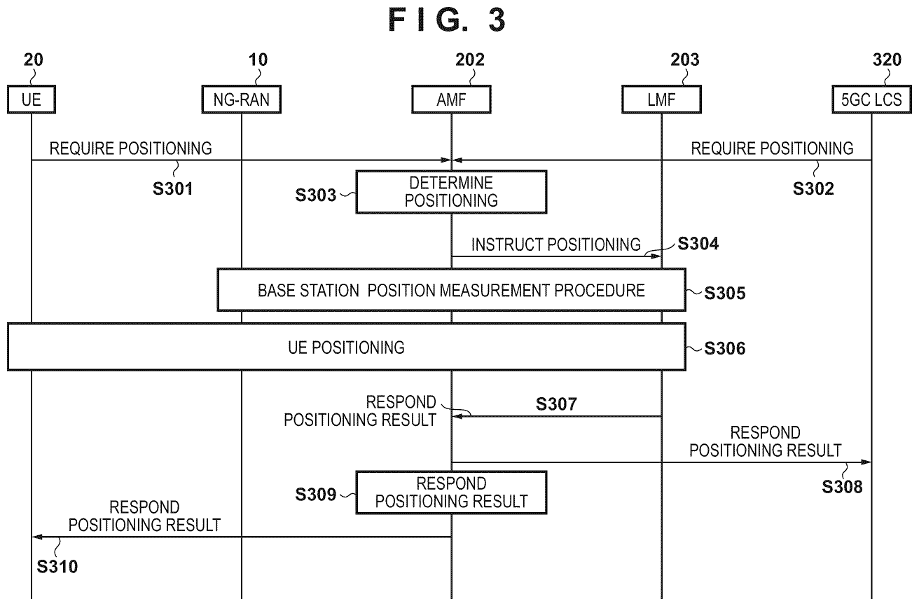

FIG. 3 is a sequence chart when executing positioning processing by the functional blocks shown in FIG. 2. Positioning processing can be started when a positioning request message is transmitted from the UE 20 to the AMF 202 via the base station apparatus 10 (processing step S301). Processing step S301 will sometimes be simply referred to as S301 hereinafter (this also applies to the remaining processing steps). In an example, if activation of an application such as a map application that requires the location information of the UE 20 is instructed, the UE 20 transmits the positioning request. Alternatively, positioning processing can also be started when a 5GC (5G Core Network) LCS (Location Service) 320 that is a network node configured to manage the location service of the positioning system 1 transmits a positioning request message to the AMF 202 (S302). Alternatively, positioning processing can also be started when the AMF 202 determines to start positioning processing under an arbitrary condition such as a predetermined time interval (S303).

Next, the AMF 202 transmits a positioning instruction message to the LMF 203 (S304), and processing from S305 is started from the LMF 203. Based on the information of the serving cell of the UE 20 or the states of adjacent cells, the LMF 203 notifies the base station apparatus 10 connected to the UE 20 of the start of positioning processing (S305). Note that if there is possibility that the base station apparatuses 10 of the adjacent cells also participate in the positioning processing, the notification is similarly transmitted. That is, in S305, the notification is transmitted to one or more base station apparatuses 10. In an example, in S305, the LMF 203 may acquire the location information of the base station apparatus 10 from the base station apparatus 10. Alternatively, in S305, the LMF 203 may acquire, from the storage unit (to be described later) of the LMF 203, the location information of the base station apparatus 10 stored in advance. Alternatively, in S305, using one of the above-described positioning methods, the positional relationship between one base station apparatus 10 and the remaining one or more base station apparatuses 10 may be specified by transmission/reception of wireless signals.

Next, the LMF 203 notifies the positioning processing of the UE 20 and specifies the position of the UE 20 based on transmission of signals between the UE 20 and the base station apparatus 10 (S306). Note that in S306, the specified location information is reported from the UE 20 or the base station apparatus 10 to the LMF 203. Alternatively, in S306, a detection result of a wireless signal between the UE 20 and the base station apparatus 10 may be transmitted to the LMF 203, and the LMF 203 may specify the position of the UE 20 based on the detection result. That is, in S306, as described above, performing transmission/reception of signals according to a known positioning method such as OTDOA or E-CID positioning suffices and it may be a network-based positioning method or a terminal-based positioning method. In the network-based positioning method, in S306, one or more base station apparatuses 10 detect a reference signal included in uplink (UL) transmission from the UE 20, and a network node such as the LMF 203 determines the position of the UE 20 based on the detection result. In the terminal-based positioning method, in S306, one or more base station apparatuses 10 transmit a wireless signal such as a PRS (Positioning Reference Signal), the UE 20 detects the wireless signal, and the UE 20 determines the position of the UE 20 based on the detection result.

Next, the LMF 203 transmits the specified location information of the UE 20 to the AMF 202 (S307), and also transmits it to the 5G LCS 320 and the UE 20 as needed (S308 and S310). The location information provided to the AMF 202 (S309) is used for a notification of an emergency call service or the like, and the location information provided to the 5G LCS is used for a service using location information by a portable telephone service provider.

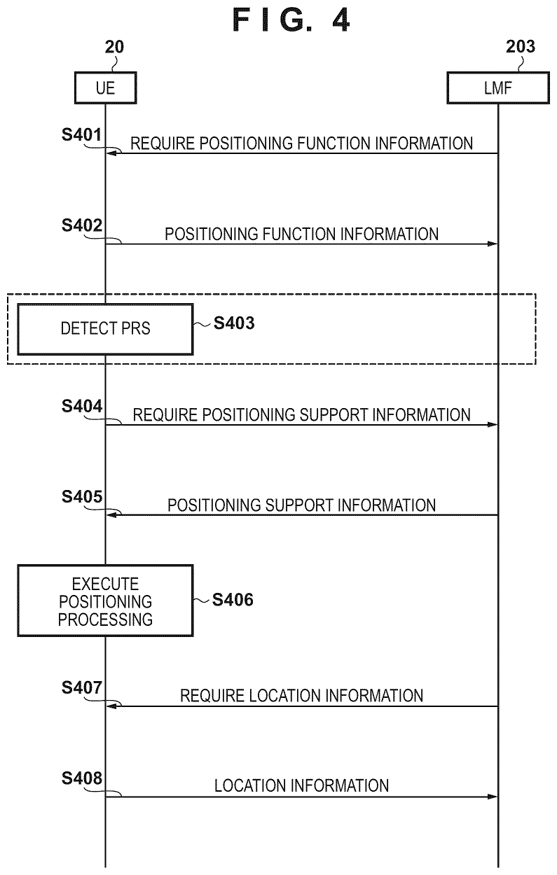

FIG. 4 shows details of the processing of S306 in FIG. 3. In S401, the LMF 203 transmits, to the UE 20, a request for confirming the capability of positioning methods supported by the UE 20 as a positioning function information request message. In an example, the LMF 203 selects executable positioning methods as candidate positioning methods based on the specifications of the serving cell of the UE 20 and the base station apparatuses 10 of adjacent cells, and transmits a positioning function information request message including information concerning the selectable positioning methods.

In response to the request in S401, the UE 20 notifies the LMF 203 of a positioning function information message including a capability indicating positioning methods that the UE 20 can execute. The UE 20 and the LMF 203 can thus grasp usable positioning methods. Note that the LMF 203 may also inquire of the base station apparatus 10 of the serving cell and the base station apparatuses 10 of the adjacent cells about executable positioning methods and acquire capability.

Next, in S403, the UE 20 receives the positioning reference signal (PRS), which is a reference signal transmitted from the base station apparatus 10 and to be used for positioning. The PRS is a downlink signal sent from the base station apparatus 10 of each of the serving cell of the UE 20 and the adjacent cells. The UE 20 determines an RSRP (reference signal received strength) as the signal strength of the PRS and an SNR (Signal to Noise Ratio) as the signal quality. Note that the UE 20 may periodically execute the processing of S403 at a predetermined time interval. Also, in an example, if activation of an application such as a map application that requires the location information of the UE 20 is instructed, the UE 20 may start detection of the PRS.

Next, in S404, the UE 20 requests positioning support information, and in S405, the LMF 203 provides positioning support information as a response. The positioning support information is information used when the UE 20 executes positioning in S406, and includes, for example, the location information of the base station apparatus 10 that provides the serving cell. In addition, the positioning support information may include the location information of the base station apparatuses 10 that provide the adjacent cells. The positioning support information request message transmitted from the UE 20 in S404 includes information indicating the positioning method that the UE 20 selects based on the reception result of S403.

Next, the UE 20 advances the process to S406 and executes positioning processing by the positioning method notified in S404. Here, the positioning processing is performed using the location information of the base station apparatus 10 acquired in S405 based on the positioning method transmitted in S404. In an example, in the positioning processing, at least one of the signal strength (RSRP) of the PRS and a signal arrival time difference (RSTD) is measured, the distance and direction from the base station apparatus 10 are specified, and the position of the UE 20 is specified based on the position of the base station apparatus 10.

After the end of the positioning processing, in S407, the LMF 203 requests location information from the UE 20, and in S408, the UE 20 transmits the location information to the LMF 203. The LMF 203 can thus acquire the location information of the UE 20. Note that in a case where positioning is executed using a network-based positioning method, since the LMF 203 specifies the location information of the UE 20 or acquires the location information of the UE 20 from a network node different from the UE 20, the processing of S407 and S408 may be omitted. Note that in an example, after the positioning processing is executed in S406, the UE 20 may transmit the location information of the UE 20 to the LMF 203 even if no location information request is received.

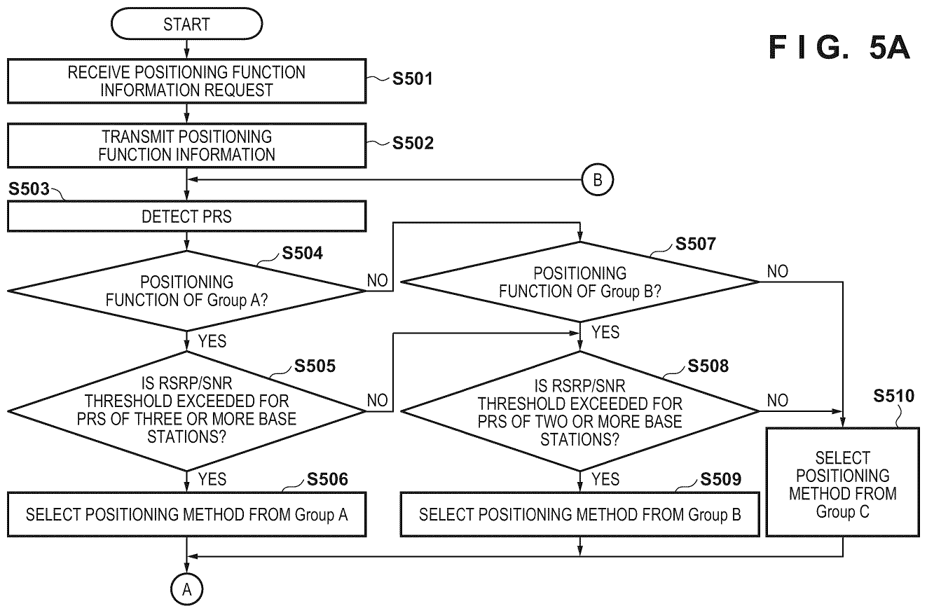

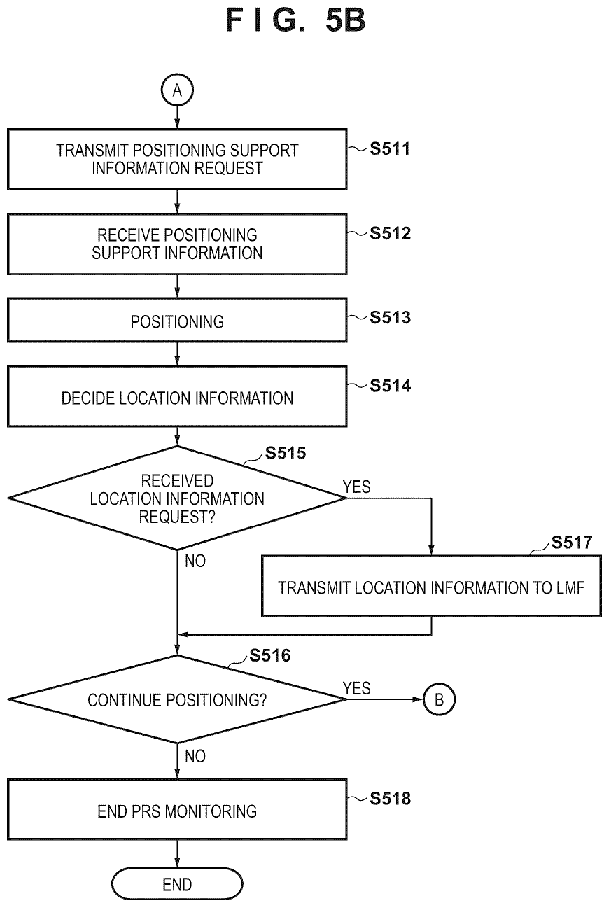

The operation flowchart of the UE 20 will be described next with reference to the flowcharts of FIGS. 5A and 5B.

As described with reference to S401, the UE 20 receives a positioning function information request from the LMF 203 that decides to execute positioning of the UE 20 (S501). Next, as described with reference to S402, in response to the positioning function information request, the UE 20 transmits positioning function information to the LMF 203 in accordance with the positioning method execution capability (capability) of its own (S502).

Next, the UE 20 detects a PRS transmitted from the base station apparatus 10 (S503), and selects a positioning method based on the detection result.

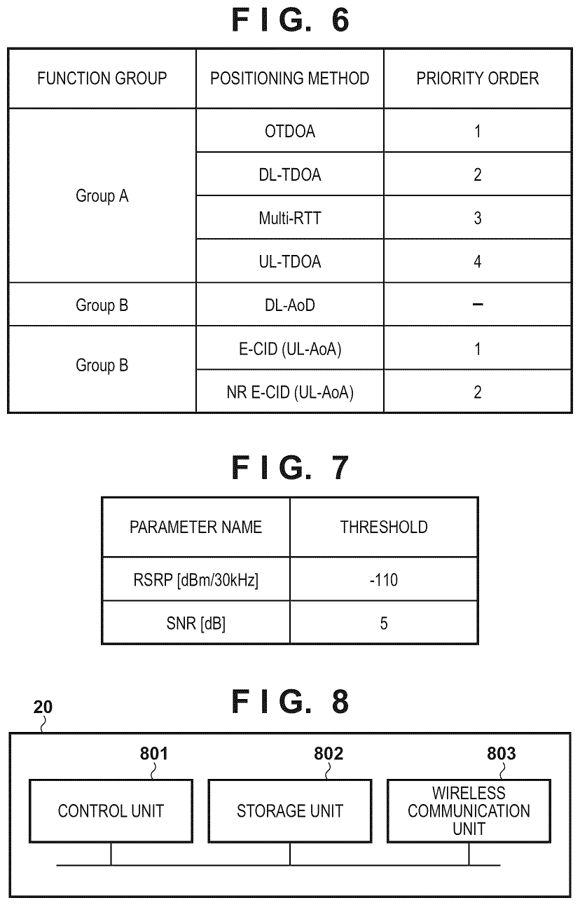

Methods of transmitting/receiving a wireless signal between a plurality of base station apparatuses 10 and the UE 20 and methods of transmitting/receiving a wireless signal between a single base station apparatus 10 and the UE 20 exist in the positioning methods. In other words, positioning methods in which the plurality of base station apparatuses 10 participate and positioning methods in which the single base station apparatus 10 participates exist in the positioning methods. In this embodiment, the positioning methods are divided into three groups based on the number of base stations used in the positioning methods. FIG. 6 shows the function groups. A Group A includes positioning methods using three or more base station apparatuses 10, a Group B includes positioning methods using two base station apparatuses 10, and a Group C includes positioning methods using a single base station apparatus 10.

Selection of a positioning method to be used from the positioning methods supported by the UE 20, which are included in the positioning function information transmitted in S502 of FIG. 5A is performed by the following processing.

In S504, the UE 20 determines whether it can execute the positioning methods of the Group A. If the UE 20 can execute the positioning methods of the Group A (YES in S504), the UE 20 advances the process to S505; otherwise (NO in S504), the UE 20 advances the process to S507.

In S505, it is determined, concerning a plurality of PRSes transmitted from three or more base station apparatuses 10, whether the RSRP and the SNR are higher than the threshold of RSRP (first threshold) and the threshold of SNR (second threshold), respectively. Note that at least one of the first threshold and the second threshold may be a different value in accordance with the frequency band on which the PRS is transmitted. The UE 20 executes the processing of S505 based on the first threshold and the second threshold, which are stored in advance or included in the request transmitted in S501. Note that if a plurality of PRSes transmitted from one base station apparatus 10 are detected in S503, it may be determined whether the average value of the RSRPs of the plurality of PRSes and the average value of the SNRs are higher than the first threshold and the second threshold. Also, if a plurality of PRSes transmitted from one base station apparatus 10 via different frequency channels are detected in S503, the UE 20 may determine, for each frequency channel, whether the RSRP and the SNR of the PRS are higher than the first threshold and the second threshold.

Upon determining in S505 that the RSRPs and the SNRs of the PRSes transmitted from the three or more base station apparatuses 10 are higher than the first threshold and the second threshold (YES in S505), the UE 20 advances the process to S506 and selects a positioning method from the Group A. At this time, the Group A can include a plurality of positioning methods, and selection is done in accordance with the following priority order.
1. OTDOA
2. DL-TDOA
3. Multi-RTT
4. UL-TDOA

Upon determining in S505 that the RSRP and the SNR of at least one of the PRSes transmitted from the three or more base station apparatuses 10 are equal to or lower than the first threshold and the second threshold (NO in S505), the UE 20 advances the process to S508.

In S507, the UE 20 determines whether it can execute the positioning methods of the Group B. If the UE 20 can execute the positioning methods of the Group B (YES in S507), the UE 20 advances the process to S508; otherwise (NO in S507), the UE 20 advances the process to S510.

In S508, it is determined, concerning a plurality of PRSes transmitted from two or more base station apparatuses 10, whether the RSRP and the SNR are higher than the threshold of RSRP (first threshold) and the threshold of SNR (second threshold), respectively. Details of the determination are the same as in S505, and a description thereof will be omitted. Upon determining in S508 that the RSRPs and the SNRs of the PRSes transmitted from the two or more base station apparatuses 10 are higher than the first threshold and the second threshold (YES in S508), the UE 20 advances the process to S509 and selects a positioning method from the Group B. Upon determining in S508 that the RSRP and the SNR of at least one of the PRSes transmitted from the two or more base station apparatuses 10 are equal to or lower than the first threshold and the second threshold (NO in S508), the UE 20 advances the process to S510.

In S509, the UE 20 selects a positioning method from the Group B. In the example shown in FIG. 6, since only DL-AoD is selectable in the Group B, DL-AoD is selected as the positioning method.

In S510, the UE 20 selects a positioning method from the Group C. More specifically, the UE 20 decides the positioning method depending on whether the serving cell is LTE or 5G NR. For example, if the serving cell is LTE, E-CID is selected as the positioning method. If the serving cell is 5G NR, NR E-CID is selected as the positioning method.

After the positioning method is selected in S506, S509, or S510, the UE 20 advances the process to S511, and transmits a positioning support information request. Here, the positioning support information includes information indicating the selected positioning method. In response to the positioning support information request, positioning support information is provided from the LMF 203 (S512). Based on the positioning support information and the measurement result of the PRS, the UE 20 executes positioning by the positioning method (S513), and specifies location information (S514).

Upon receiving a location information request from the LMF 203 (YES in S515), the UE 20 transmits the location information to the LMF 203 (S517) and advances the process to S516.

If no location information request is received from the LMF 203 (NO in S515), the UE 20 advances the process to S516 and determines whether to continue positioning. For example, in a case where the UE 20 is executing an application that requires location information of the UE 20, the UE 20 may determine to end the positioning upon receiving an end instruction for the application, and may determine to continue the positioning if the end instruction is not received. To continue the positioning (YES in S516), the UE 20 returns the process to S503 and detects the PRS. To end the positioning (NO in S516), the UE 20 advances the process to S518. In S518, the UE 20 ends the detection of the PRS and ends the flowcharts shown in FIGS. 5A and 5B.

The thresholds of the RSRP and the SNR of the PRS will be described next with reference to FIG. 7. A situation in which the RSRP lowers occurs in a case where the base station apparatus 10 is located far away, or if an obstacle exists between the UE 20 and the base station apparatus 10, or communication becomes impossible due to a change of the wireless environment caused by slight movement or the like. A situation in which the SNR lowers occurs in a case where the RSRP is low, and additionally, if communication may be impossible because of multipath fading or inter-cel interference, or the existence of an interference wave or disturbance wave from another system including devices other than portable telephones. Hence, if these values are lower than the thresholds, the communication environment is not excellent, and positioning accuracy may lower. For this reason, the positioning method is selected such that the base station apparatus 10 for which the PRS lower than the threshold is detected is not used for positioning processing. Note that as described above, as for setting of the threshold, a plurality of thresholds may be set in accordance with the frequency channel to transmit the PRS or the frequency channel to transmit by the UE 20 in positioning processing.

As described above, the UE 20 according to this embodiment detects a wireless signal transmitted from one or more base station apparatuses 10, and selects the positioning method to be used based on the detection result of the received signal strength or received signal quality. It is therefore possible to continue positioning using an appropriate positioning method even if the wireless environment changes due to movement of the UE 20 after the start of positioning. Also, it is possible to prevent positioning from being performed using the base station apparatus 10 whose positioning accuracy is likely to be low and thus prevent the positioning accuracy from lowering.

The hardware configuration of the UE 20 will be described next with reference to FIG. 8. The UE 20 includes a control unit 801, a storage unit 802, and a wireless communication unit 803.

As an example, the control unit 801 is configured to include one or more processors such as a CPU (Central Processing Unit) or an MPU (Micro Processing Unit), and one or more memories. The processor of the control unit 801 executes a program stored in the memory, thereby executing processing described with reference to FIGS. 5A and 5B. Note that the control unit 801 may include an application specific integrated circuit (ASIC) or field programmable gate array (FPGA) configured to execute the processing shown in FIGS. 5A and 5B.

The storage unit 802 is a storage device that stores programs to be executed by the processor of the control unit 801 and various kinds of data to be used by the programs. The storage unit 802 stores, for example, the list of positioning methods shown in FIG. 6 and the thresholds of the RSRP and SNR of the PRS shown in FIG. 7. Note that if the positioning methods supported by the positioning system 1 change, the UE 20 may acquire information about the list of positioning methods from an external apparatus and update the data stored in the storage unit 802.

The wireless communication unit 803 includes a wireless communication circuit that is connected to the base station apparatus 10 and detects the PRS transmitted from the base station apparatus 10.

Note that in this embodiment, the description has been made assuming that the UE 20 selects the positioning method. However, a network node of a RAN (Radio Access Network) or a core network may select the positioning method. In this case, the UE 20 that detects the PRS in S403 transmits the detection result to the network node, and the network node selects a positioning method based on the acquired detection result and controls the UE 20 or the base station apparatus 10 to execute the selected positioning method. That is, a control apparatus that controls to acquire the detection result of the PRS by the UE 20, select one of a plurality of positioning methods based on the acquired PRS detection result, and execute positioning processing using the selected positioning method may be provided in the UE 20, the base station apparatus 10, or a network node including the LMF 203 and the AMF 202.

According to one aspect of the present disclosure, it is possible to prevent lowering of positioning accuracy due to the wireless environment between a base station and a terminal.

### <Other Embodiments>

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The values of the first threshold and the second threshold used to determine whether to use the base station apparatus 10 for positioning may change depending on the application that the UE 20 uses. For example, if the UE 20 is an apparatus such as a drone that can autonomously move and a moving path control application is used, or if the UE 20 uses a map application, the first threshold and the second threshold may be set relatively high. On the other hand, if the UE 20 is a smartphone and uses, for example, a game application that uses location information, the first threshold and the second threshold may be set relatively low. These settings are stored in the UE 20 in advance.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

1. A control apparatus for controlling positioning based on communication between one or more cellular base station and a terminal, comprising:
at least one memory that stores a set of instructions; and
at least one processor that executes the instructions, the instructions, when executed, causing the control apparatus to perform operations comprising:
obtaining a detection result of a wireless signal transmitted from the one or more cellular base station, which is detected by the terminal;
performing selection processing for selecting one of a plurality of positioning methods based on the obtained detection result; and
controlling to execute positioning processing using the positioning method selected by the selection processing,
wherein in the selection processing, in a case where the detection result is a first detection result, a first positioning method based on a radio wave state between the one or more cellular base station and the terminal is selected, and in a case where the detection result is a second detection result, a second positioning method, which is different from the first positioning method, based on the radio wave state between the one or more cellular base station and the terminal is selected.

2. The control apparatus according to claim 1, wherein in the selection processing, in a case where the detection result indicates at least one of a state in which a received signal strength, at the terminal, of the wireless signal transmitted from a predetermined cellular base station is higher than a first threshold and a state in which a signal to noise ratio (SNR) is higher than a second threshold, a positioning method using the predetermined cellular base station is selected.

3. The control apparatus according to claim 2, wherein in the selection processing, in a case where the detection result indicates at least one of a state in which the received signal strength, at the terminal, of each of wireless signals transmitted from a plurality of cellular base stations in the one or more cellular base station is higher than the first threshold and the state in which the signal to noise ratio (SNR) is higher than the second threshold, a positioning method using the plurality of cellular base stations is selected.

4. The control apparatus according to claim 2, wherein the first threshold and the second threshold have different values in accordance with a frequency band to transmit the wireless signal.

5. The control apparatus according to claim 1, wherein the plurality of positioning methods include at least one of OTDOA (Observed Time Difference Of Arrival), E-CID (Enhanced Cell ID) positioning, DL-TDOA (Downlink-Time Difference of Arrival), DL-AoD (Downlink-Angle of Departure), Multi-RTT (Roundtrip Time) positioning, UL-TDOA (Uplink-Time Difference of Arrival), and UL-AoA (Uplink-Angle of Arrival).

6. The control apparatus according to claim 1, wherein the operations further comprise transmitting information about the positioning method selected by the selection processing.

7. The control apparatus according to claim 1, wherein the operations further comprise controlling so as to receive information about the plurality of positioning methods before the selection processing.

8. The control apparatus according to claim 7, wherein
the control apparatus is provided in the terminal,
the terminal is a user apparatus configured to perform communication complying with the 3GPP® standard, and
the external apparatus is a Location Management Function.

9. The control apparatus according to claim 1, wherein the detection result includes a received signal strength and received signal quality, at the terminal, of a positioning reference signal (PRS) transmitted from the one or more cellular base station.

10. The control apparatus according to claim 9, wherein the controlling includes, as the positioning processing, controlling for causing the terminal detect the PRS transmitted from at least one of the one or more base station.

11. The control apparatus according to claim 1, wherein the controlling includes, as the positioning processing, controlling for causing at least one of the one or more cellular base station detect a wireless signal transmitted from the terminal.

12. The control apparatus according to claim 1, wherein the operations further comprise controlling to receive, from the external apparatus, information about a position of a cellular base station participating in the positioning processing.

13. The control apparatus according to claim 1, wherein the control apparatus is provided in the terminal.

14. The control apparatus according to claim 13, wherein the obtaining comprises obtaining the detection result by starting detection of the wireless signal in a case where activation of an application that requires location information of the terminal is instructed.

15. The control apparatus according to claim 1, wherein
the terminal is a user apparatus configured to perform communication complying with the 3GPP® standard, and
the control apparatus is provided in a network node of one of a Radio Access Network and a core network.

16. A control method of a control apparatus for controlling positioning based on communication between one or more cellular base station and a terminal, comprising:
obtaining a detection result of a wireless signal transmitted from the one or more cellular base station, which is detected by the terminal;
selecting one of a plurality of positioning methods based on the obtained detection result; and
controlling to execute positioning processing using the selected positioning method,
wherein in a case where the detection result is a first detection result, a first positioning method based on a radio wave state between the one or more cellular base station and the terminal is selected, and in a case where the detection result is a second detection result, a second positioning method, which is different from the first positioning method, based on the radio wave state between the one or more cellular base station and the terminal is selected.

17. A non-transitory computer-readable storage medium storing a program for causing a computer of a control apparatus for controlling positioning based on communication between one or more cellular base station and a terminal, to perform:
obtaining a detection result of a wireless signal transmitted from the one or more cellular base station, which is detected by the terminal;
selecting one of a plurality of positioning methods based on the obtained detection result; and
controlling to execute positioning processing using the selected positioning method,
wherein in a case where the detection result is a first detection result, a first positioning method based on a radio wave state between the one or more cellular base station and the terminal is selected, and in a case where the detection result is a second detection result, a second positioning method, which is different from the first positioning method, based on the radio wave state between the one or more cellular base station and the terminal is selected.
